(19) United States
(12) Patent Application Publication
(10) Pub. No.: US 2020/0112198 A1
(43) Pub. Date: Apr. 9, 2020

(54) SMART GRID PROTECTION SYSTEM AND SMART GRID PROTECTION METHOD

(71) Applicant: Ming-Tsung Chen, Taipei City (TW)

(72) Inventors: MING-TSUNG CHEN, Taipei City (TW); SZU-MEI SUN, Taoyuan City (TW)

(21) Appl. No.: 16/151,677

(22) Filed: Oct. 4, 2018

(51) Int. Cl. H02J 13/00; H02H 1/00; G05B 19/042; H04W 4/80

(52) U.S. Cl. CPC H02J 13/0017; H02H 1/0007; G05B 2219/2639; G05B 19/0428; H04W 4/80; H02H 1/0092

(57) ABSTRACT

A smart grid protection system includes a first power protection device and a second power protection device. When a first power consumption and leakage detection module detects that the power consumption of a first power circuit is larger than a first threshold or that the first power circuit has a leakage current, the first power protection device notifies a first power control switch for adjusting an output power of the first power circuit. A first low energy Bluetooth communication module of the first power protection device notifies a second low energy Bluetooth communication module of the second power protection device for correspondingly adjusting the second power control switch of the second power control node.

### FIELD OF THE DISCLOSURE

The present disclosure relates to a protection system and a protection method, and more particularly to a protection system and a protection method for a smart grid.

### BACKGROUND OF THE DISCLOSURE

Ever since the introduction of smart meters, smart grids have been gradually popularized. However, today's smart meters only perform data feedback over wired or wireless networks, and cannot provide active protection in special situations. In other words, each power node can only rely on safety switches as a protective mechanism, and cannot use various power information of the smart grid in a predetermined area to protect themselves.

Therefore, providing a smart grid protection system is an important topic in the industry.

### SUMMARY OF THE DISCLOSURE

In response to the above-referenced technical inadequacies, the present disclosure provides a smart grid protection system. The smart grid protection system is in a grid system. The grid system includes a first power circuit and a second power circuit. The first power circuit includes at least one first power line and a first power control node. The second power circuit includes at least one second power line and a second power control node. The first power control node includes a first power control switch. The second power control node includes a second power control switch. The smart grid protection system includes: a first power protection device installed in the first power control node of the first power circuit, and electrically connected to the first power control node, and a second power protection device installed in the second power control node of the second power circuit, and electrically connected to the second power control node. The first power protection device includes: a first power consumption and leakage detection module for detecting a power consumption value and a leakage state of the first power circuit; a first low energy Bluetooth communication module; and a first energy storing module electrically connected to the first power consumption and leakage detection module and the first low energy Bluetooth communication module, and providing power to the first power consumption and leakage detection module and the first low energy Bluetooth communication module. The second power protection device includes: a second power consumption and leakage detection module for detecting a power consumption value and a leakage state of the second power circuit; a second low energy Bluetooth communication module; and a second energy storing module, electrically connected to the second power consumption and leakage detection module and the second low energy Bluetooth communication module, and providing power to the second power consumption and leakage detection module and the second low energy Bluetooth communication module. When the first power consumption and leakage detection module detects that the power consumption of the first power circuit is larger than a first threshold or that the first power circuit has a leakage current, the first power protection device notifies the first power control switch for adjusting the output power of the first power circuit. The first low energy Bluetooth communication module of the first power protection device notifies the second low energy Bluetooth communication module of the second power protection device for correspondingly adjusting the second power control switch of the second power control node.

In certain embodiments, the present disclosure provides that the first low energy Bluetooth communication module transmits a first broadcasting signal for communicating with the second low energy Bluetooth communication module.

In certain embodiments, the present disclosure provides that the first power protection device further includes: a first temperature protection module electrically connected to the first low energy Bluetooth communication module. When the first temperature protection module detects that a temperature of the first power control node is larger than a first temperature, the first power protection device provides an over temperature signal to the first power control node for adjusting an output power of the first power circuit, and the first power protection device provides an alert signal to the second power protection device through the first low energy Bluetooth communication module.

In certain embodiments, the present disclosure provides that the second power protection device further includes: a second temperature protection module electrically connected to the second low energy Bluetooth communication module. When the second temperature protection module detects that a temperature of the second power control node is larger than a first temperature, the second power protection device provides an over temperature signal to the second power control node for adjusting an output power of the second power circuit, the second power protection device provides an alert signal to the first power protection device through the second low energy Bluetooth communication module.

In certain embodiments, the present disclosure provides that the first low energy Bluetooth communication module and the second low energy Bluetooth communication module communicate with each other in a Bluetooth 4.0 standard or in a Bluetooth 5.0 standard.

In one aspect, the present disclosure provides a smart grid protection method. The grid system at least includes a first power circuit and a second power circuit. The first power circuit includes at least one first power line. The second power circuit includes at least one second power line. The first power circuit includes a first power control node. The second power circuit includes a second power control node. The first power control node has a first power control switch. The second power control node has a second power control switch. The smart grid protection method includes: using a first power protection device to detect a power consumption and a leakage state of the first power circuit, when the power consumption or the leakage state is not in a normal range, the first power protection operates in a protection mode; adjusting an output power of the first power circuit according to the protection mode of the first power protection device; and notifying a second power protection device of the second power circuit for adjusting an output power of the second power circuit by a Bluetooth broadcasting signal.

In certain embodiments, the present disclosure provides that the smart grid protection method further includes: determining whether an alert signal is transmitted by detecting a temperature of each power control node or an environment of each power control node.

In certain embodiments, the present disclosure provides that the first power protection device and a second power protection device The first power protection device includes: a first power consumption and leakage detection module for detecting a power consumption value and a leakage state of the first power circuit; a first low energy Bluetooth communication module; and a first energy storing module, electrically connected to the first power consumption and leakage detection module and the first low energy Bluetooth communication module, and providing power to the first power consumption and leakage detection module and the first low energy Bluetooth communication module. The second power protection device includes: a second power consumption and leakage detection module for detecting a power consumption value and a leakage state of the second power circuit; a second low energy Bluetooth communication module; and a second energy storing module electrically connected to the second power consumption and leakage detection module and the second low energy Bluetooth communication module, and providing power to the second power consumption and leakage detection module and the second low energy Bluetooth communication module.

In certain embodiments, the present disclosure provides that the first low energy Bluetooth communication module transmits a first broadcasting signal for communicating with the second low energy Bluetooth communication module.

In certain embodiments, the present disclosure provides that the first power protection device further includes: a first temperature protection module, electrically connected to the first low energy Bluetooth communication module. When the first temperature protection module detects that a temperature of the first power control node is larger than a first temperature, the first power protection device provides an over temperature signal to the first power control node for adjusting an output power of the first power circuit, and the first power protection device provides an alert signal to the second power protection device through the first low energy Bluetooth communication module.

In certain embodiments, the present disclosure provides that the first low energy Bluetooth communication module and the second low energy Bluetooth communication module communicate with each other in a Bluetooth 4.0 standard or in a Bluetooth 5.0 standard.

According to the above, the smart grid protection system of the present disclosure uses the power protection device communicated by the Bluetooth standard to detect abnormal power states, and notifies the power protection device installed in other power control nodes at the same power area through broadcasting signals for adjusting the power of each of the power circuits.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic diagram of a smart grid protection system according to an embodiment of the present disclosure.

FIG. 2 is a schematic diagram of a first power protection device and a second power protection device according to an embodiment of the present disclosure.

FIG. 3 is a flow chart of a smart grid protection method according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

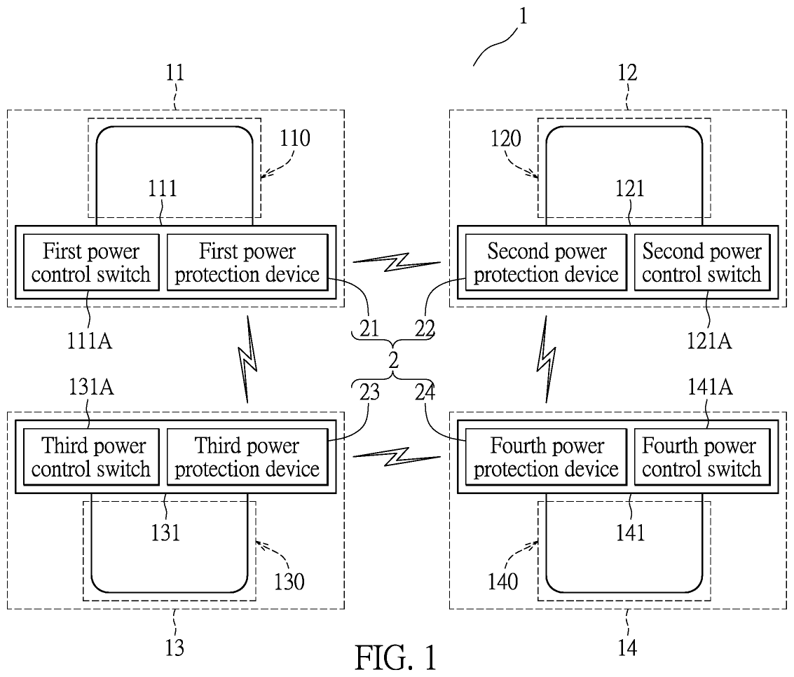

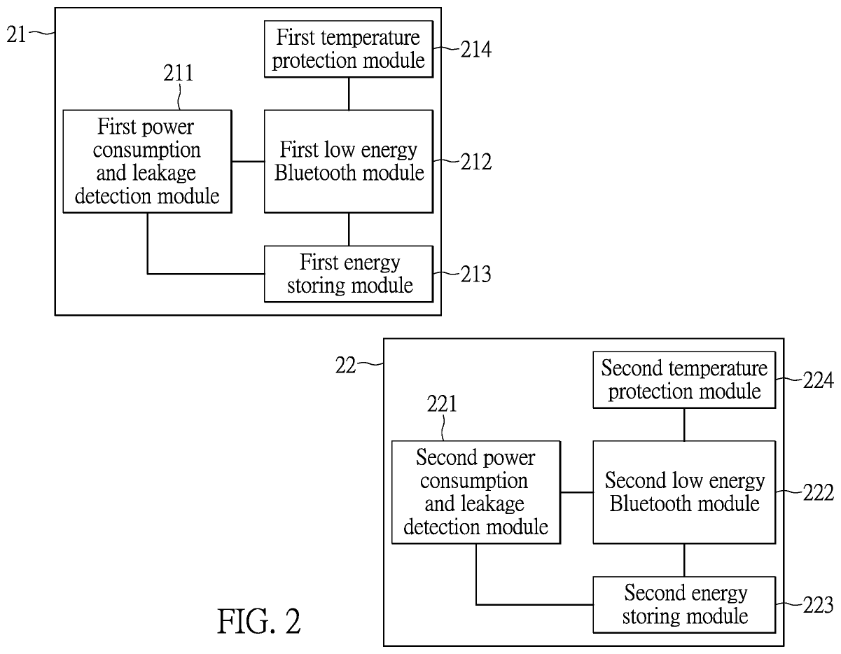

Referring to FIG. 1 and FIG. 2, FIG. 1 is a schematic diagram of a smart grid protection system according to an embodiment of the present disclosure. FIG. 2 is a schematic diagram of a first power protection device and a second power protection device according to an embodiment of the present disclosure.

In the embodiment, the smart grid protection system 2 is installed in a grid system 1. The grid system 1 at least includes two power circuits. In other words, the power circuits are respectively controlled by two control nodes. In the embodiment, the grid system 1 includes a first power circuit 11, a second power circuit 12, a third power circuit 13, and a fourth power circuit 14. In the embodiment, the grid system 1 is installed in a power area (not shown), a size of the power area is not limited in the present disclosure.

Each power circuit at least includes one power line. In other words, the first power circuit 11 at least includes a first power line 110. The second power circuit 12 at least includes a second power line 120. The third power circuit 13 at least includes a third power line 130. The fourth power circuit 14 at least includes a fourth power line 140.

Accordingly, each power circuit also includes one power control node installed in each power circuit. In the embodiment, the first power circuit 11 includes a first power control node 111 electrically connected to the first power line 110. The second power circuit 12 includes a second power control node 121 electrically connected to the second power line 120. The third power circuit 13 includes a third power control node 131 electrically connected to the third power line 130. The fourth power circuit 14 includes a fourth power control node 141 electrically connected to the fourth power line 140.

The first power control node 111 includes a first power switch 111A. The second power control node 121 includes a second power switch 121A. The third power control node 11 includes a third power switch 131A. The fourth power control node 11 includes a fourth power switch 141A.

In the embodiment, the smart grid protection system 2 includes at least two power protection devices. The smart grid protection system 2 includes a first power protection device 21, a second power protection device 22, a third power protection device 23 and a fourth power protection device 24. The first power protection device 21, the second power protection device 22, the third power protection device 23, and the fourth power protection device 24 are respectively installed in the first power control node 111, the second power control node 121, the third power control node 131, and the fourth power control node 141 for detecting power consumptions and leakage states of the first power circuit 11, the second power circuit 12, the third power circuit 13, and the fourth power circuit 14. The power consumption of each power circuit is the electricity consumption value of each power circuit. The leakage state of the power circuit is caused by a circuit malfunction which results in an overcurrent.

In the embodiment, the first power protection device 21 is electrically connected to the first power control switch 111A and the first power line 110. The second power protection device 22 is electrically connected to the second power control switch 121A and the second power line 120. The third power protection device 23 is electrically connected to the third power control switch 131A and the third power line 130. The fourth power protection device 24 is electrically connected to the fourth power control switch 141A and the fourth power line 140.

The following description takes the first power protection device 21 and the second power protection device 22 as examples. The third power protection device 23 and the fourth power protection device 24 are similar to the first power protection device 21 and the second power protection device 22, which are omitted in the following description.

The first power protection device 21 includes a first power consumption and leakage detection module 211, a first low energy Bluetooth communication module 212, a first energy storing module 213, and a first temperature protection module 214. The second power protection device 22 includes a second power consumption and leakage detection module 221, a second low energy Bluetooth communication module 222, a second energy storing module 223, and a second temperature protection module 224.

In the embodiment, the first low energy Bluetooth communication module 212 and the second low energy Bluetooth communication module 222 use the Bluetooth 4.0 and the Bluetooth 5.0 standard for communicating with each other, which can be designed according to the practical requirements and is not limited in the present disclosure. The first low energy Bluetooth communication module 212 transmits a first broadcasting signal for communicating with the second low energy Bluetooth communication module 222. Similarly, the second low energy Bluetooth communication module 222 transmits a second broadcasting signal for communicating with the first low energy Bluetooth communication module 222.

The first power consumption and leakage detection module 211 and the second power consumption and leakage detection module 221 are used for detecting power consumption and leakage states of the first power circuit 11 and the second power circuit 12.

The first energy storing module 213 is electrically connected to the first power consumption and leakage detection module 211 and the first low energy Bluetooth communication module 212. The first energy storing module 213 provides the power to the first power consumption and leakage detection module 211 and the first low energy Bluetooth communication module 212.

The second energy storing module 223 is electrically connected to the second power consumption and leakage detection module 221 and the second low energy Bluetooth communication module 222. The second energy storing module 223 provides the power to the second power consumption and leakage detection module 221 and the second low energy Bluetooth communication module 212.

In the embodiment, the first energy storing module 213 and the second energy storing module 213 include a super capacitor, or a long lasting battery unit, but is not limited in the present disclosure.

The first temperature protection module 214 is electrically connected to the first low energy Bluetooth communication module 212.

When the first temperature protection module 214 detects that a temperature of the first power control node 111 or an environment temperature is larger than a first temperature, the first power protection device 21 provides an over-temperature signal to the first power control switch 1111 for adjusting an output power of the first power circuit 11. In the embodiment, the first temperature is between 50° C. and 70° C. In the embodiment, when the first temperature protection module 214 detects that a temperature of the first power control node 111 or an environment temperature is larger than a second temperature, the first power protection device 21 notifies the first power control switch 111A to cut off power from the first power circuit 11. In the embodiment, the second temperature is between 90° C. and 150° C.

The first power protection device 21 provides an alert signal to notify the second power protection device 22 through the first low energy Bluetooth communication module 212 such that the first power control switch 111A adjusts the power of the first power circuit 11.

The second power protection device 22 provides an alert signal to notify the first power protection device 21 through the second low energy Bluetooth communication module 222 such that the second power control switch 121A adjusts the power of the first power circuit 11.

In addition, when the first power consumption and leakage detection module 211 of the first power protection device 21 detects that a power consumption of the first power circuit 11 is larger than a first threshold or the first power circuit 11 has a leakage current, the first power protection device 21 notifies the first power control switch 111A for adjusting the power of the first power circuit or cutting off the power of the first power circuit 11.

The first low energy Bluetooth module 212 of the first power protection device 21 notifies the second low energy Bluetooth module 222 of the second power protection device 22, such that the second power protection device 22 correspondingly adjusts the output power of the second power control switch 121A of the second power control node 121.

Furthermore, when the second power consumption and leakage detection module 221 of the second power protection device 22 detects that a power consumption of the second power circuit 12 is larger than a first threshold or the second power circuit 12 has a leakage current, the second power protection device 22 notifies the second power control switch 121A for adjusting the power of the second power circuit 12 or cutting off the power of the first power circuit 12.

The second low energy Bluetooth module 222 of the second power protection device 22 notifies the second low energy Bluetooth module 222 of the second power protection device 22, such that the second power protection device 22 correspondingly adjusts the output power of the second power control switch 121A of the second power control node 121.

In the embodiment, the numbers of the power circuit, the power control nodes, the power line, the power control switch, and the power protection device is not limited to the number described in the above description, and can be designed based on actual requirements, which is not limited in the present disclosure.

### Second Embodiment

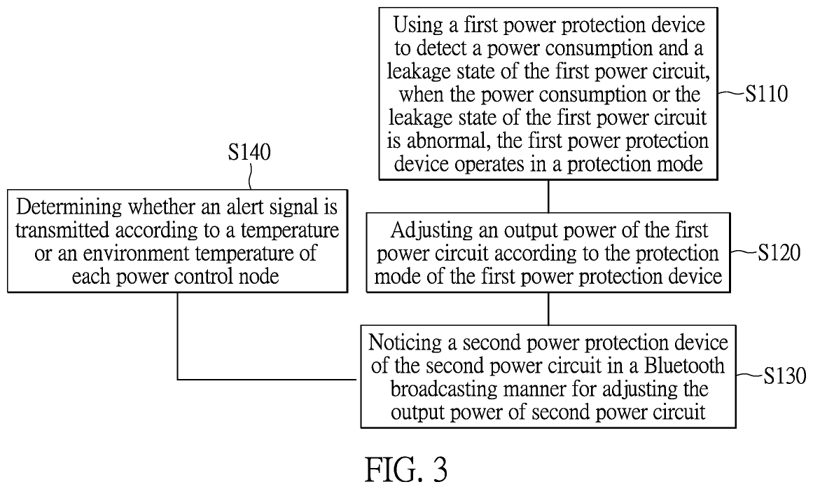

Referring to FIG. 3, FIG. 3 is a flow chart of a smart grid protection method according to an embodiment of the present disclosure.

A smart grid protection method is provided in the embodiment of the present disclosure, which is adapted for the above grid system 1 and the smart grid protection system 2.

In the embodiment, the smart grid protection method includes the following steps:

Using a first power protection device to detect a power consumption and a leakage state of the first power circuit, when the power consumption or the leakage state of the first power circuit is abnormal, the first power protection device operates in a protection mode (Step S110);

Adjusting an output power of the first power circuit according to the protection mode of the first power protection device (Step S120); and

Notifying a second power protection device of the second power circuit by Bluetooth broadcasting for adjusting the output power of the second power circuit (Step S130).

In Step S110 and Step S120, when the first power consumption and leakage detection module 211 of the first power protection device 21 detects that the power consumption of the first power circuit 21 is larger than a first threshold or the first power circuit 11 has a leakage current, the first power protection device 21 notifies the first power control switch 111A for adjusting the power consumption of the first power circuit 11. In other words, the power of the first power circuit 11 is reduced or cut off, accordingly, and the first power protection device 21 operates in the protection mode.

In Step S130, the first low energy Bluetooth communication device 212 transmits a first broadcast to notify the second low energy Bluetooth communication device 222 of the second power protection device 22 such that the second power protection device 22 correspondingly adjusts the output power of the second power control switch 121A of the second power control node 121.

In the embodiment, the smart grid protection method further includes the following step:

Determining whether an alert signal is transmitted according to a temperature or an environment temperature of each power control node (Step S140).

In Step S140, when the first temperature protection module 214 detects that a temperature of the first power control node 111 or an environment temperature is larger than a first temperature, the first power protection device 21 provides an over temperature signal to the first power control switch 1111 for adjusting an output power of the first power circuit 11. In the embodiment, the first temperature is between 50° C. and 70° C. In the embodiment, when the first temperature protection module 214 detects that a temperature of the first power control node 111 or an environment temperature is larger than a second temperature, the first power protection device 21 notifies the first power control switch 111A to cut off power from the first power circuit 11. In the embodiment, the second temperature is between 90° C. and 150° C.

The first power protection device 21 provides an alert signal to notify the second power protection device 22 through the first low energy Bluetooth communication module 212 such that the first power control switch 111A adjusts the power of the first power circuit 11.

Similarly, the second temperature protection module 224 is electrically connected to the second low energy Bluetooth communication module 222.

When the second temperature protection module 224 detects that a temperature of the second power control node 121 or an environment temperature is larger than a first temperature, the second power protection device 22 provides an over temperature signal to the second power control switch 121A for adjusting an output power of the second power circuit 12. In the embodiment, the first temperature is between 50° C. and 70° C. In the embodiment, when the second temperature protection module 224 detects that a temperature of the second power control node 111 or an environment temperature is larger than a second temperature, the second power protection device 22 notifies the second power control switch 121A to cut off power for the second power circuit 11. In the embodiment, the second temperature is between 90° C. and 150° C.

The second power protection device 22 provides an alert signal to notify the first power protection device 21 through the second low energy Bluetooth communication module 222 such that the second power control switch 121A adjusts the power of the first power circuit 11.

According to the above, the smart grid protection system of the present disclosure uses the power protection device communicated by the Bluetooth standard to detect an abnormal power state, and notifies the power protection device installed in other power control nodes at the same power area through broadcasting signals for adjusting the power of each of the power circuits.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A smart grid protection system, implemented in a grid system, wherein the grid system includes a first power circuit and a second power circuit, the first power circuit includes at least one first power line and a first power control node, the second power circuit includes at least one second power line and a second power control node, the first power control node includes a first power control switch, the second power control node includes a second power control switch, the smart grid protection system comprising:
a first power protection device installed in the first power control node of the first power circuit and electrically connected to the first power control node, wherein the first power protection device includes:
a first power consumption and leakage detection module for detecting a power consumption value and a leakage state of the first power circuit;
a first low energy Bluetooth communication module; and
a first energy storing module electrically connected to the first power consumption and leakage detection module and the first low energy Bluetooth communication module, and providing power to the first power consumption and leakage detection module and the first low energy Bluetooth communication module;
a second power protection device installed in the second power control node of the second power circuit, and electrically connected to the second power control node, wherein the second power protection device includes:
a second power consumption and leakage detection module for detecting a power consumption value and a leakage state of the second power circuit;
a second low energy Bluetooth communication module; and
a second energy storing module, electrically connected to the second power consumption and leakage detection module and the second low energy Bluetooth communication module, and providing power to the second power consumption and leakage detection module and the second low energy Bluetooth communication module;
wherein when the first power consumption and leakage detection module detects that the power consumption of the first power circuit is larger than a first threshold or that the first power circuit has a leakage current, the first power protection device notifies the first power control switch for adjusting the output power of the first power circuit;
wherein the first low energy Bluetooth communication module of the first power protection device notifies the second low energy Bluetooth communication module of the second power protection device for correspondingly adjusting the second power control switch of the second power control node.

2. The smart grid protection system of claim 1, wherein the first low energy Bluetooth communication module transmits a first broadcasting signal for communicating with the second low energy Bluetooth communication module.

3. The smart grid protection system of claim 1, wherein the first power protection device further includes:
a first temperature protection module electrically connected to the first low energy Bluetooth communication module;
wherein when the first temperature protection module detects that a temperature of the first power control node is larger than a first temperature, the first power protection device provides an over temperature signal to the first power control node for adjusting an output power of the first power circuit, and the first power protection device provides an alert signal to the second power protection device through the first low energy Bluetooth communication module.

4. The smart grid protection system of claim 1, wherein the second power protection device further includes:
a second temperature protection module electrically connected to the second low energy Bluetooth communication module;
wherein when the second temperature protection module detects that a temperature of the second power control node is larger than a first temperature, the second power protection device provides an over temperature signal to the second power control node for adjusting an output power of the second power circuit, and the second power protection device provides an alert signal to the first power protection device through the second low energy Bluetooth communication module.

5. The smart grid protection system of claim 1, wherein the first low energy Bluetooth communication module and the second low energy Bluetooth communication module communicate with each other in a Bluetooth 4.0 standard or in a Bluetooth 5.0 standard.

6. A smart grid protection method used in a grid system, wherein the grid system at least includes a first power circuit and a second power circuit, the first power circuit includes at least one first power line, the second power circuit includes at least one second power line, the first power circuit includes a first power control node, and the second power circuit includes a second power control node, the first power control node has a first power control switch, the second power control node has a second power control switch, the smart grid protection method comprising:
using a first power protection device to detect a power consumption and a leakage state of the first power circuit, when the power consumption or the leakage state is not in a normal range, the first power protection operates in a protection mode;
adjusting an output power of the first power circuit according to the protection mode of the first power protection device; and
notifying a second power protection device of the second power circuit for adjusting an output power of the second power circuit by a Bluetooth broadcasting signal.

7. The smart grid protection method of claim 6, further comprising:
determining whether an alert signal is transmitted by detecting a temperature of each power control node or an environment temperature of each power control node.

8. The smart grid protection method of claim 6, wherein the first power protection device includes:
a first power consumption and leakage detection module for detecting a power consumption value and a leakage state of the first power circuit;
a first low energy Bluetooth communication module; and
a first energy storing module electrically connected to the first power consumption and leakage detection module and the first low energy Bluetooth communication module, and providing power to the first power consumption and leakage detection module and the first low energy Bluetooth communication module;
a second power protection device installed in the second power control node of the second power circuit, and electrically connected to the second power control node, wherein the second power protection device includes:
a second power consumption and leakage detection module for detecting a power consumption value and a leakage state of the second power circuit;
a second low energy Bluetooth communication module; and
a second energy storing module electrically connected to the second power consumption and leakage detection module and the second low energy Bluetooth communication module, and providing power to the second power consumption and leakage detection module and the second low energy Bluetooth communication module.

9. The smart grid protection method of claim 7, wherein the first low energy Bluetooth communication module transmits a first broadcasting signal for communicating with the second low energy Bluetooth communication module.

10. The smart grid protection method of claim 7, wherein the first power protection device further includes:
a first temperature protection module, electrically connected to the first low energy Bluetooth communication module;
wherein when the first temperature protection module detects that a temperature of the first power control node is larger than a first temperature, the first power protection device provides an over temperature signal to the first power control node for adjusting an output power of the first power circuit, and the first power protection device provides an alert signal to the second power protection device through the first low energy Bluetooth communication module.

11. The smart grid protection method of claim 7, wherein the first low energy Bluetooth communication module and the second low energy Bluetooth communication module communicate with each other in a Bluetooth 4.0 standard or in a Bluetooth 5.0 standard.
